(19) United States
(12) Patent Application Publication
(10) Pub. No.: US 2007/0260488 A1
(43) Pub. Date: Nov. 8, 2007

(54) Medical reference image data, and method for producing them

(76) Inventors: Sylvia Heywang-Kobrunner, Baldham (DE); Markus Schmidt, Nurnberg (DE); Ulrike Schwarz-Boeger, Munchen (DE); Gudrun Zahlmann, Neumarkt (DE)

Correspondence Address: HARNESS, DICKEY & PIERCE, P.L.C., P.O.BOX 8910, RESTON, VA, 20195, US

(21) Appl. No.: 11/785,445

(22) Filed: Apr. 18, 2007

(30) Foreign Application Priority Data
Apr. 18, 2006 (DE) 10 2006 017 840.8
Apr. 18, 2006 (DE) 10 2006 017 838.6

(51) Int. Cl. G06Q 10/00; G06K 9/00

(52) U.S. Cl. 705/2; 382/128

(57) ABSTRACT

In a method for producing medical reference image data of a patient, medical image data are produced from the patient in order to present a medical diagnosis. In at least one embodiment of the method, verification data correlated with the medical image data are collected from the patient to verify the diagnosis and the diagnosis verified with the aid of the verification data is stored inseparably together with the image data as the medical reference image data. In medical reference image data of a patient, medical image data produced from the patient are present to present a medical diagnosis and verification data collected from the patient and correlated with the medical image data are present to verify the diagnosis. In at least one embodiment, the diagnosis verified with the aid of the verification data is stored inseparably together with the image data as the medical reference image data.

### PRIORITY STATEMENT

The present application hereby claims priority under 35 U.S.C. §119 on German patent application numbers DE 10 2006 017 840.8 filed Apr. 18, 2006 and DE 10 2006 017 838.6 filed Apr. 18, 2006, the entire contents of each of which is hereby incorporated herein by reference.

### FIELD

Embodiments of the invention generally relate to a method for producing medical reference image data of a patient, and/or to corresponding medical reference image data.

### BACKGROUND

Imaging methods are being introduced more and more into everyday medical practice. This applies to all areas of medicine, such as medical practices, hospitals or even mobile units, for example in an ambulance. Consequently more and more medical images are available for an individual patient owing to the continuously increasing imaging methods and/or imaging medical devices.

Since imaging methods currently operate digitally as a rule, the images are usually available as computer readable data, for example, in the form of an image file. Even images in originally analog form, for example an X-ray film or a paper printout of an ultrasonic image, can be appropriately digitized.

The evaluation of medical image data, for example an interpretation thereof, the preparation of a diagnosis or similar, by a reader for example a doctor, is a very complex procedure that requires human experience and the capacity to judge. Since the interpretation and, in particular, the taking of a medical decision, for example a course of treatment, on the basis of image data is therefore subject to error, there are so called “gold standard” methods for backing up a diagnosis presented by the doctor on the basis of image data.

In the case of a cancer diagnosis this is, for example, the taking of a histopathological sample of the patient at the site correspondingly diagnosed in the medical image. Alternatively, it is possible, for example, for the results of a genomic test to provide reliable statements, and therefore gold standard information. These gold standard methods supply information in the form of a generally written report that has, in turn, been prepared by a human expert or an algorithm.

The image data of a patient are mostly stored in the data processing system of a medical practice or of a hospital information system, not as individual files as a rule, but in an image data record. In addition to the actual image data, that is to say the image information, the latter includes, for example, identification data of the patient such as name and date of birth thereof. However, there are also frequently stored in the corresponding data record the doctor's comments, diagnoses, courses of treatment, and the like.

Even when such information is stored in the image data record together with the image data, it is still necessary, nevertheless, for the image reader to link them in his brain to the image data at each instant as he views the image in order, for example, to be able to take a reliable therapeutic decision. To the extent that these additional data relate at all to image data stored in the image data record, they are, nevertheless, dependent of the image data per se or not directly linked to them.

The connection between image data and additional information must be made each time that the image reader views the image anew, for example even at points in time occurring weeks or months later. This applies likewise to image data prepared at a later point in time, for example during a course of treatment of the patient or the patients on the basis of the previously presented diagnosis and referring to one and the same patient. The new image data must then also be brought together in the reader's brain with, for example, the old image data and the gold standard information.

The most varied problems arise in this case: the image reader can, for example, overlook or leave out of consideration gold standard information or other information that is necessary for evaluating the image viewed, and thus reach different diagnoses of the image at different points in time. At different points in time, the image reader can consider different image regions in the image data to be relevant, and also thus reach different diagnoses.

To date, there is no technical support for the above described procedure, that is to say the simultaneous consideration of image material and associated information.

Owing to the above named multiplicity of medical image data that are available for a patient, it has also recently become desirable to carry out medical studies on the basis of medical image data.

However, problems are raised by the carrying out of clinical studies on the basis of medical images or image data, since image information per se is not structured. As mentioned above, human experience or expert knowledge is required in order to obtain from image data structured information that can be used for the analytical process of a clinical study.

### SUMMARY

In at least one embodiment of the present invention, the doctor is offered technical assistance here.

With regard to a method of at least one embodiment, a method is disclosed for producing medical reference image data of a patient having the following steps: medical image data are produced from the patient in order to present a medical diagnosis. Verification data correlated with the medical image data are collected from the patient in order to verify the diagnosis. The diagnosis verified with the aid of the verification data is stored inseparably together with the image data as the medical reference image data.

Thus, in the method according to at least one embodiment of the invention, medical reference image data are produced that include both the image data themselves and a diagnosis that relates to these image data, has been verified and being stored inseparably together. “Inseparably” is to be understood here to the effect that, for example, a reading of the image always necessarily entails the presentation, or indication of the diagnosis, at least for the duration of use of the image data or the reference image data. For example, these data are always displayed to the reader of the image data jointly on a monitor. Verification data correlated with the diagnosis can be all data that are collected with the aid of the image data. For example, a therapy measure that requires genomic tests can be carried out on the patient. Such genomic tests can supply as verification data (verified) findings data that are prepared, however, without a prior image reading of the patient image. An image reading is therefore not mandatory before production of the verification data.

Owing to the inseparable storage, the diagnostic data are also presented, for example, to each reader, that is to say person deciding on the reference image data and/or the image data of the patient that are included therein. It follows that an image reader can neither overlook the diagnosis once prepared with the aid of the image data and verified by the verification data, nor can he thereby forget or confuse said diagnosis. It is thereby ensured that there is also complete reliability of diagnosis with reference to the diagnosis based on the image data whenever use is made of the reference image data instead of the sole use of the image data. However, owing to the verification data the corresponding diagnosis is reliably backed up and likewise inseparably linked to the image data.

Thus, medical reference data can be used to achieve reliability of diagnosis with reference to a diagnosis prepared on the basis of image data. Specifically, in the relevant reference image data both the image data on which the diagnosis is based, and the diagnosis backed up by the collection of gold standard information are stored inseparably together in a data record, specifically medical reference data.

Thus, with regard to a clinical study structural information is stored in medical reference image data in the course of the method. This is based on the first medical image data recorded from the patient. Thus, what happens here is that image information of the first image data is appropriately linked to the additional information in accordance with a gold standard for confirming a diagnosis prepared with the aid of the image data.

Storing the verified diagnosis in the reference image data results in structured information that therefore includes the characteristic parameters for image data. Consequently, the renewed reading of image data is also performed, together with the diagnosis, in the structure prescribed by the reference image data.

At the end of the clinical study, or during its course, each reading of an image of a patient that has been produced can be performed within the predefined structure in order thus to obtain quantitative results in the respective image data.

The reference image data therefore form a type of pattern for structured information. This pattern is valid during the entire study, including the information additionally stored in the reference image data. Both quality and standardization of the clinical study are thereby yielded as advantages.

The verification data can also be collected with the aid of a diagnosis based on a found site in the image data. The verification data are thus then correlated as a rule not only with the diagnosis, but also with the found site. Thus, for example, a biopsy is usually taken precisely exactly at the found site, in order precisely, for example, to examine the body tissue of a patient that is present exactly there. The found site is also thereby stored in the medical reference image data. In such a case, contrary to the above the obtaining of verification data is generally preceded by an image reading of the image data.

Thus, to be specific, it is possible in this way firstly to discover the found site and, as it were, thereby to initiate the taking of the verification data. The found site of the diagnosis in the image therefore constitutes the connecting link between the image represented by the image data and the diagnosis. The found site is thus indubitably stored in the reference image data for the reader due to the correlation with the diagnosis, there being no need to search anew for the found site in the image. Since, for example the position data of the found site are stored, the found site can be picked up indubitably at any time in the image data.

At least a portion of the verification data can be stored in the reference image data. This also ensures inseparable access to the stored verification data when reading the reference image data. The reader can also neither forget nor overlook said data. More detailed additional information is thereby provided on the basis of the reading of the reference image data.

The found site can be stored as image information in the image data. In this case, the image data are already included in the reference image data. There is also a change to this storage location for the found site, that is to say in the image data instead of, for example, a text file in the reference image data, or to the way in which they are stored, that is to say pictorially instead of, for example, as coordinates in text form. The found site or its location is therefore immediately visible when reading the image. The reader is not compelled to this end firstly to evaluate coordinates or the like. The image information can easily be detected immediately, and cannot be overlooked. A reticle, a colored marker or the like, for example, can be displayed as image information.

The reader is therefore simultaneously reminded of the diagnosis solely by reading the image data in the reference image data. He need not firstly read the diagnosis in, for example, text form in a file shown, for example, simultaneously together with the image data, and assign it to the image. The risk of an involuntary disregard of the diagnosis during image reading is thereby further reduced.

The found site can be stored not only in punctiform fashion, but also in the form of a region marker for a subregion of the image data. Thus, for example, it is possible not only for the middle point, but also for the entire region of interest of a corresponding found site to be stored in the reference image data. Furthermore the extent of the corresponding image region is thereby indubitably stored in the reference image data.

It is particularly evident in this case to the reader of the reference image data or image data when the region marker is stored as an optical accentuation of the subregion, in particular a borderline around the subregion.

Since a doctor generally prepares a therapy plan for the corresponding patient on the basis of a diagnosis presented in image data and verified with absolute certainty (for example gold standard data as verification data), it is correspondingly possible for desired therapy data correlated with the diagnosis, that is to say, for example, concrete instructions of the therapy plan for a therapy to be carried out on the patient, also to be stored in the reference image data. Consequently, the therapy plan is also uniquely stored, in the form of the desired therapy data, in the reference image data inseparably with the image data and diagnosis. The therapy plan is therefore presented to the reader automatically and in a fashion incapable of being overlooked with each reading of reference image data.

Corresponding actual therapy data can also be stored in the reference image data in accordance with the desired data for a therapy. Such data can be useful for storing a course of therapy or therapy success for a therapy carried out on the patient. Consequently, with each reading of the image data within the reference image data, the reader can automatically see the course of therapy for the corresponding diagnosis of the patient, or he is referred thereto.

During a clinical study, it has been customary for the purpose of obtaining structured information for a human image reader to establish a region of interest (ROI) in an image on the basis of his experience and/or his expert knowledge in a first image reading. However, if the clinical study extends, for example, over a lengthy time, in particular treatment carried out on the corresponding patient, the ROIs can change, grow, shrink or similar in the course of time. The respective image reader of an image recorded at different points in time must therefore respectively detect anew the instantaneous status of an ROI and put this into relation with previous image readings.

It follows that the analysis of such processes, for example of courses of treatment or similar for a number of patients require the above named status information (ROI, diagnosis . . . ) of an individual patient to be compared over many different images and/or image data in order, for example, to be able to document changes, a course of treatment or the like of an individual patient in a structured fashion for the clinical study.

Solutions currently exist that back up the identification and/or extraction of a specific parameter from a single image in each case. Thus, for example, there are evaluation standards for cancer diagnoses (determination of the RECIST), for the determination of a tumor diameter or the like. However, there are no methods of any sort for finding an ROI again, or redefining it, for different readings of one or more images that would permit a valid image comparison and are based on structured information.

Particularly in this case, the method according to at least one embodiment of the invention is suitable as a starting point where the image data addressed have been produced as first image data of a patient. In one refinement of at least one embodiment of the method, it is then possible, specifically, that at least second image data of the patient corresponding to the first image data are produced for the clinical study, the second image data are stored in the reference image data, and the reference image data are evaluated in order to obtain study information.

Thus, structured information such as, for example, the found location, that is to say the position of the ROI, and other parameters are stored in medical reference image data. This is based on the first medical image data firstly recorded from the patient. What happens here is thus an appropriate linking of the image information of the first image data to the additional information in accordance with the gold standard, in order to confirm a diagnosis prepared with the aid of the image data.

However, in the course of the clinical study further, that is to say second image data are produced from the patient at least once, but mostly more often. Since all these second image data are produced from the patient at a point in time other than the first data, it is possible in the meantime for the ROIs, found location or diagnosis, for example, to have changed in the image. Consequently, the second image data are also stored in the reference image data, and the reference image data are evaluated in their totality in order to obtain study information.

The storage of the found location and the verified diagnosis in the reference image data gives rise to structured information that therefore includes the characteristic parameters for the first image data. Owing to the fact that the second image data are also stored in the reference image data and, furthermore, that the reference image data are always evaluated in their totality, subsequent image readings, that is to say also those of the second image data, utilize the structured information in the reference image data. The renewed reading of, for example, the ROIs and their description in the form of a diagnosis or similar is therefore also performed in the structure prescribed by the reference image data. By way of the subsequent storage of each set of second image data, that is to say on a number of medical images, as well, always in the reference image data, and of the respective evaluation of the reference image data in their totality, it is possible at the end of the clinical study or during its course to perform a comparison of all the image readings of all the produced images of the patient within the predefined structure in order thus to obtain quantitative results of the variations in the respective image data.

The reference image data therefore form a sort of pattern for structured information. This pattern describes, for example, both the position and other parameters of the ROIs in the medical image data. This pattern, including the information additionally stored in the reference image data, is valid for all subsequent images, that is to say the second image data. The pattern can be used so as to obtain new status information relating to second image data in the same way as that of the first image data. Both quality and standardization of the clinical study are thereby yielded as advantages.

Particularly for ROIs and thus found sites that are changing, specifically in the case of a first found site in the first image, the second found site is therefore also stored in the reference image data if a second found site differing from the first is determined in the first or second image data when study information obtaining.

If a portion of the verification data is also stored in the reference image data, it is not only the backed up diagnosis but also the corresponding gold standard information from the verification data themselves that are available for the purpose of also being incorporated, if necessary, when obtaining study information from first or second image data.

The found site can be stored in the reference image data as image information in the image data. A reader of the first or second image data then need not firstly, for example, evaluate coordinate information relating to the found site, but sees the latter marked in the image data at a glance.

In order also to be able to delimit the ROIs more effectively with reference to their extent, a region marker for a subregion of the image data can be stored as found site.

This region marker is particularly well visible when it is stored as an optical accentuation of the subregion, in particular as a borderline around the subregion, in the image data.

In order to obtain study information, the first image data and second image data of the reference image data can be evaluated. Particularly when none of the additional information from the reference image data whatsoever is considered here, it is possible thus to carry out purely image-based clinical studies. It can, for example, be investigated here how different readers interpret respective image data and manifest them in the form of a diagnosis.

In order to obtain study information, the first image data and second image data can respectively be compared. As a result of the image comparison, it is thus possible, in particular, to extract changes between individual recorded image data in the course of a clinical study. This is sensible, for example, in order to determine the course of a disease or success of a therapy in the case of an individual patient in the course of the clinical study.

In particular, it is therefore possible to produce the second image data during a course of treatment on the patient. The course of treatment on a patient for example with a new drug, can thus be documented and evaluated not only, as previously, in textual, but also in pictorial form during the clinical study.

Since clinical studies are generally carried out on a multiplicity of patients, it is possible in each case to produce reference image data of various patients, and to compare the respective reference image data in order to obtain study information.

In the course of a clinical study, the study data correspondingly collected by the individual evaluators independently of one another are monitored and/or evaluated by a further person, a so called monitor.

There is the problem here that the evaluation by the monitor is extremely difficult, since the latter cannot replicate how the individual evaluator results or reaches his personal study of the image data, specifically by the image reading of the image data. Thus, the monitor is, unable to duplicate which image region has been judged by the individual reader to be an ROI for example, how the latter has arrived at the tumor diameter, etc. The verification of the study data determined by the evaluators can thus be checked only with the aid of a variable derived from the image data, but not with the aid of the image data themselves. This was easily possible in prior clinical studies not supported by images since, for example, it was possible to test against data in a patient file. In the present case, however, it is only the corresponding image of the patient, for example, that exists.

Since, however, there are now reference image data of each patient that can be evaluated by the study monitor, the latter firstly has available the above named structured information, and secondly diagnoses respectively verified in accordance with the gold standard, and/or further information are stored in relation to each set of image data in the reference image data that, for example, specify the position of the ROIs, etc. This renders possible an effective comparison and an evaluation of the individual study data by the study monitor.

In order to facilitate the work of the study monitor, the respective reference image data can be preprocessed to form a result image that is evaluated in order to obtain study information. This also provides for the study monitor the advantage that the latter can evaluate the reference image data of individual patients purely on the basis of images. Reading the result image alone is simpler here than evaluating individual image data together with additional information, for example in textual form.

In particular, it is thereby possible for the differences between various found sites to be optically accentuated in the result image. It is thus immediately obvious to the study monitor, for example, for which patient, or by which study doctor or the like deviating found sites or diagnoses have been determined. The evaluation or the release or the rejection of specific study information by the study monitor is thereby simplified.

With regard to the inventive data, the object is achieved by means of medical reference image data of a patient, medical image data produced from the patient being present in order to present a medical diagnosis, and verification data collected from the patient and correlated with the medical image data being present in order to verify the diagnosis in the case of which the diagnosis verified with the aid of the verification data is stored inseparably together with the image data as the medical reference image data.

The inventive medical reference image data correspond to the reference image data produced with the aid of at least one embodiment of the above described method. The advantages resulting herefrom have already been explained in conjunction with at least one embodiment of the method and also for advantageous configurations of the reference image data.

### BRIEF DESCRIPTION OF THE DRAWINGS

Reference is made for a further description of the invention to the example embodiments of the drawings in which, in a schematic sketch in each case:

FIG. 1 shows the production of medical reference image data from a patient,

FIG. 2 shows the therapeutic treatment of the patient from FIG. 1 with the aid of the reference image data, and

FIG. 3 shows a sequence diagram for data collection during an image-based clinical study.

### DETAILED DESCRIPTION OF THE EXAMPLE EMBODIMENTS

The terminology used herein is for the purpose of describing particular embodiments only and is not intended to be limiting of the present invention. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referencing the drawings, wherein like reference numerals designate identical or corresponding parts throughout the several views, example embodiments of the present patent application are hereafter described. Like numbers refer to like elements throughout. As used herein, the term “and/or” includes any and all combinations of one or more of the associated listed items.

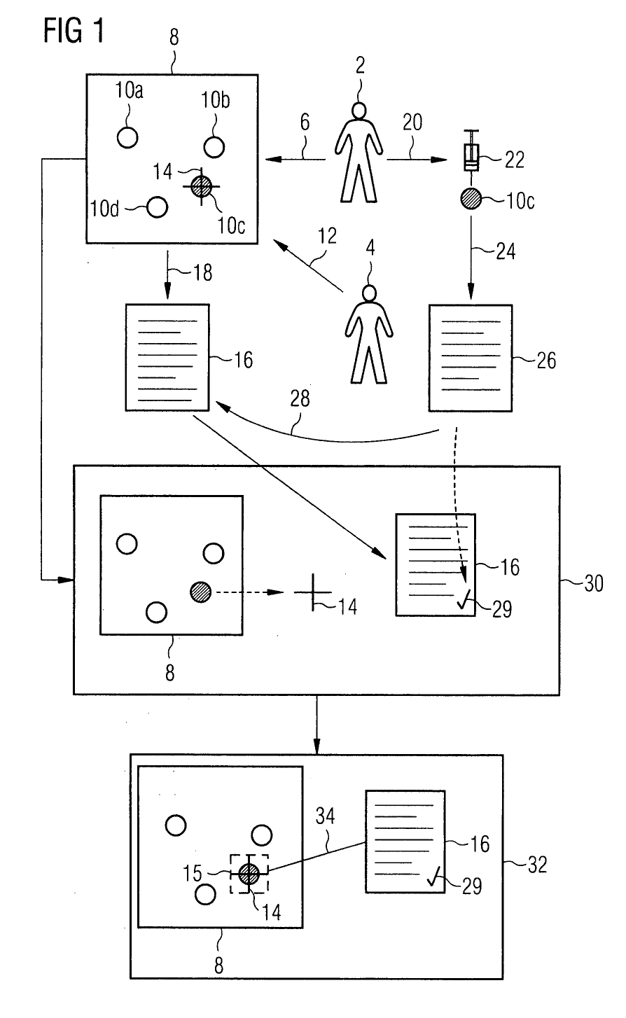

FIG. 1 shows a patient 2 who is consulting a doctor 4 because of trouble with his health. As indicated by the arrow 6, the doctor thereupon orders an X-ray image 8 of the patient 2 to be recorded. Various body structures 10a-d of the patient 2, such as bone and tissue, are imaged on the X-ray image 8. As indicated by the arrow 12, the doctor is viewing the X-ray image 8. At a certain position, specifically the found site 14, indicated by a reticle, the doctor 4 discovers an anomaly at the body structure 10c. The doctor 4 thereupon prepares a diagnosis 16 in the form of a diagnostic report, indicated by the arrow 18, in written form as to the fact that the body structure 10c is specifically a tumor. As an alternative to the punctiform marker, the doctor can also draw a frame 15 around the found site 14 that, for example, outlines the tumor.

Since the diagnosis 16 based on the X-ray image 8 is uncertain, as indicated by the arrow 20 the doctor orders a biopsy on the patient 2 or the body structure 10c. A tissue sample is removed from the body structure 10c when the biopsy is taken, as indicated in FIG. 1 by the biopsy needle 22, and is analyzed. Thus, a biopsy report 26 is produced, as indicated by the arrow 24. The biopsy report 26 identifies the body structure 10c indubitably as a tumor. The examination and diagnosis of the patient 2 is thereby concluded. Since the biopsy is absolutely reliable, a gold standard method is present here. The diagnosis 16 at the found site 14 in the patient 2 is confirmed by the biopsy report 26. This is indicated in FIG. 1 by a verification 29 in the form of a confirmation sign on the biopsy report, representing the diagnosis 16. These three items of information thus cohere inseparably. It is now important also to archive this information inseparably.

The X-ray image 8, the diagnosis 16 verified by the biopsy report 26 and the found site 14 are therefore archived by the doctor 4 in a common reference data record 30 for later use. The X-ray image 8, found site 14, or its spatial coordinates, and the diagnosis 16 are stored inseparably with one another in the reference data record 30. To this end, the reference data record 30 is stored in a practice management system of the doctor 4 (which is not illustrated). Upon each future reading of the X-ray image 8 on a monitor 32 connected to the practice management system, the found site 14 and the diagnosis 16 confirmed by the verification 29 are always indicated inseparably together with the X-ray image 8. The fact that this belongs to the found site 14 is illustrated by a connecting line 34 on the monitor 32. Owing to the verification 29, the biopsy report 26 is also denoted as gold standard information, since this indubitably substantiates the diagnosis 16 with 100% certainty.

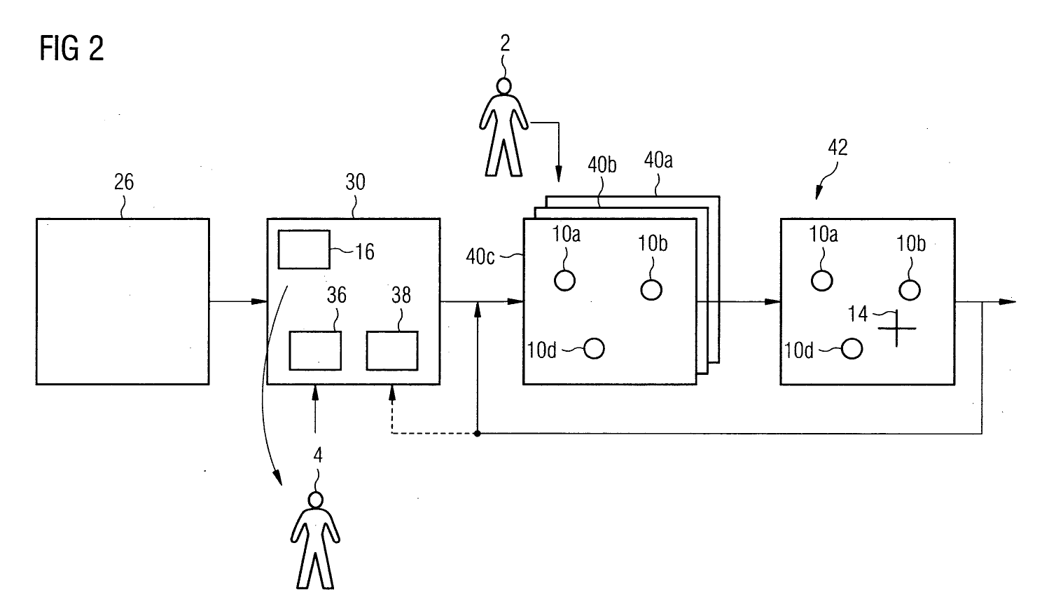

FIG. 2 shows once more how a reference data record 30 corresponding to an embodiment of the inventive reference image data is produced from the biopsy report 26 as gold standard information using an embodiment of the inventive method.

In FIG. 2, the doctor 4 uses the confirmed diagnosis 16 to prepare a therapy plan 36 for the patient 2. The doctor also stores the therapy plan 36 inseparably together with the previous data in the reference data record 30. Consequently, the therapy plan is also united with all previous data in the reference data record 30 in a way such that it cannot be lost or overlooked.

The therapy plan 36 is carried out on the patient 2 on the basis of the verified diagnosis 16. A chemotherapy is carried out on the patient. In the course thereof, X-ray images 40a, b, c corresponding to the X-ray image 8 of the patient 2 are repeatedly recorded. Since the X-ray images 40a-c correspond with reference to the display region to the X-ray image 8, the same body areas of the patient are also displayed, as are thereby the body structures 10a-d. Since all the X-ray images 40a-c belong to the same patient 2 of the reference data record 30, all the contents of the reference data record 30 also apply to them. Consequently, the found site 14 is also valid for each of the X-ray images 40a-c, and is also inserted into the corresponding X-ray images 40a-c. Specifically, after each therapy step the correspondingly recorded current X-ray image 40a-c is respectively matched with the reference data record 30.

Consequently, in the matching step 42 the found site 14 is inserted into the X-ray image 40c last recorded. By reading the X-ray image 40c thus modified, the doctor 4 detects that the body structure 10c at the found site 14 has vanished, and thus that the tumor has been successfully destroyed by the chemotherapy. Thanks to the found site 14 inserted in the X-ray image 40c in the form of the reticle, it is also impossible for the body structure 10b to be mistaken for the changed or modified tumor, originally 10d, that is to say to be confused therewith.

The diagnosis 16 of the images 40a-c is therefore also 100% diagnostically certain with reference to the diagnosis report verified by the biopsy report 26, since the corresponding information gains entry via the reference data record 30 to the X-ray images 40a-c without the need to carry out a dedicated biopsy separately for these in each case.

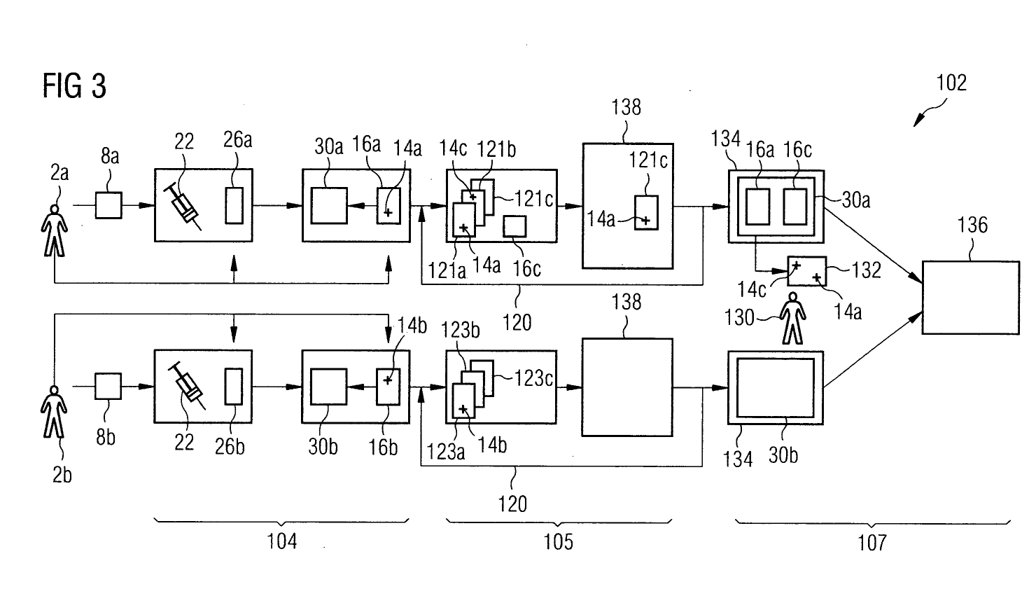

FIG. 3 shows a segment from evaluating process 102 of a clinical study. Said process is divided into a preparatory phase 104, an evaluation phase 105 and a monitoring phase 107.

In the preparatory phase 104, individual X-ray images 8a, b of different patients 2a, b are respectively prepared. The X-ray images 2a, b, correspond here to the first image data according to an embodiment of the invention.

Diagnoses 16a, b in the form of diagnostic reports, relating to the patients 2a, b and/or the X-ray image 8a, b are prepared with the aid of the X-ray images 8a, b by a committee of experts (not illustrated). In order to confirm the diagnoses 16a, b, specifically of a respective finding of a tumor on the patient 2a, b, in the example, biopsies are taken at corresponding found sites 14a, b of the tumors in the X-ray image 8a, b, represented in FIG. 1 by reticles, biopsies being illustrated in FIG. 1 by a biopsy needle 22.

The biopsy constitutes a gold standard method for backing up diagnoses 16a, b, and it confirms the diagnoses 16a, b with absolute certainty at the found sites 14a, b. The biopsy leads to biopsy reports 26a, b that are stored in reference data records 30a, b together with the X-ray images 8a, b, the found sites 14a, b and the diagnoses 16a, b. The reference data records therefore include all reliably verified findings data of the respective patient 2a, b.

In the evaluation phase 105 of the clinical study, a chemotherapy is carried out in each case on the patient 2a, b. As indicated by the loops 120, in the course of the chemotherapy X-ray images 121a-c and 123a-c are respectively recorded repeatedly in accordance with the X-ray images 8a, b of the patient 2a and 2b. Since the X-ray images 121a-c and 123a-c correspond with reference to their display region to the respective X-ray images 8a, b, the same body regions of the patients 2a, b are also displayed. Since, for example, all the X-ray images 121a-c belong to the same patient 2a as the reference data record 30a, all the contents of the reference data record 30a apply to these, as well. Consequently, the found site 14a is also valid for each of the X-ray images 121a-c, and is also inserted into the corresponding X-ray images 121a-c.

A pass for the patient 2a, that is to say the upper branch in FIG. 3, is explained below; it is, however, also valid for the patient 2b in a transferred sense.

Specifically, after each therapy step, that is to say pass of the loop 120, the correspondingly recorded current x-ray image 121a-c is respectively matched to the reference data record 30a. Consequently, in the matching step 138 the found site 14a is inserted into the last recorded X-ray image 121c. By reading the X-ray image 121c thus modified, the doctor recognizes that the tumor has disappeared at the found site 14a, that is to say that the tumor has been destroyed successfully by the chemotherapy. Thanks to the found site 14a, inserted into the X-ray image 121c, in the form of the reticle, it is also impossible to mistake a body structure lying near for the changed or modified tumor, that is to say to confuse it therewith.

In the second pass of the loop 120, that is to say on the X-ray image 121b, however, the doctor detects a new found site 14c which he notes in this image, and therefore also in the reference data 18a. The doctor prepares in relation to the found site 14c a diagnosis 16c, which he likewise stores in the reference data record 30a.

Since all the diagnoses, further findings etc. in the therapy steps of the loop 120 are always stored in the reference data record 30a, b or are matched therewith, this gives rise to a predefined structure for the collection of data during the clinical study. For example, each diagnosis of the images 121a-c is also 100% diagnostically certain with reference to the diagnoses 16a, b verified by the biopsy report 26a, b, since the corresponding information is introduced into the X-ray images 121a-c and 123a-c, respectively, via the reference data record 30a, b, without the need to carry out a dedicated biopsy separately in each case therefor.

The evaluation phase 105 of the clinical study is thereby concluded.

In the monitoring phase 107, a monitor 130 charged with monitoring the study monitors the X-ray images 8a and 121a-c and 8b and 123a-c prepared for the patients 2a, b, this being done in a comparison step 134. These are respectively jointly combined in the corresponding reference data records 30a, b. In order to enable the monitor 30 to conduct a comparison or to simplify it, all the X-ray images 10a and 121a-c are combined visually in a reader image 132. The latter includes the X-ray image 8a in which all the found sites 14a and 14c found in the course of the therapy and marked are combined with the associated diagnoses. The correspondence between the found sites 124a-c and the diagnoses 16a and 16c is produced in the reader image 132, for example by a connecting line (not illustrated).

The monitor 130 recognizes that the found sites 14a and 14c are different. By comparing with the reference data record 30a, the monitor 130 establishes furthermore that the found site 14a together with the diagnosis 16a correspond to the found site 14a confirmed in accordance with the gold standard. It follows that the found site 14c is demonstrably of no significance to the study and can be ruled out for further use from the clinical study.

This is prompted by the monitor 130 in the release step 136 of the clinical study. By contrast, the found site 14a is released for the study together with the success of the treatment documented in the reference data record 30a.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for producing medical reference image data of a patient, the method comprising:
producing medical image data from the patient to present a medical diagnosis;
collecting verification data, correlated with the medical image data, from the patient to verify the diagnosis; and
producing the medical reference image data by storing the diagnosis, verified with the aid of the verification data, inseparably together with the image data.

2. The method as claimed in claim 1, wherein the verification data are collected with the aid of the diagnosis based on a found site in the image data, and wherein the found site is stored in the medical reference image data.

3. The method as claimed in claim 1, wherein at least a portion of the verification data is stored in the reference image data.

4. The method as claimed in claim 1, wherein the found site is stored as image information in the image data of the reference image data.

5. The method as claimed in claim 4, wherein a region marker for a subregion of the image data is stored as found site.

6. The method as claimed in claim 5, wherein an optical accentuation of the subregion is stored as region marker.

7. The method as claimed in claim 1, wherein desired therapy data, correlated with the diagnosis, are stored in the reference image data for a therapy to be carried out on the patient.

8. The method as claimed in claim 1, wherein, in the course of a therapy carried out on the patient with the aid of the diagnosis, actual therapy data correlated therewith are stored in the reference image data.

9. The method as claimed in claim 1, wherein the image data are first image data and wherein the method further comprises:
producing at least second image data of the patient corresponding to the first image data for the clinical study;
storing the second image data in the reference image data; and
evaluating the reference image data to obtain study information.

10. The method as claimed in claim 9, wherein any diagnosis based on a first found site in the first image data is stored in the reference image data, in the case of which a second found site differing from the first found site is determined when obtaining study information, and in the case of which the second found site is stored in the reference image data.

11. The method as claimed in claim 9, wherein at least a portion of the verification data is stored in the reference image data.

12. The method as claimed in claim 9, wherein the found site is stored as image information in the image data.

13. The method as claimed in claim 12, wherein a region marker for a subregion of the image data is stored as found site.

14. The method as claimed in claim 13, wherein an optical accentuation of the subregion is stored as region marker.

15. The method as claimed in claim 9, wherein the first image data and second image data of the reference image data are evaluated to obtain study information.

16. The method as claimed in claim 15, wherein the first image data and second image data are compared to obtain study information.

17. The method as claimed in claim 9, wherein the second image data are produced during a course of treatment on the patient.

18. The method as claimed in claim 9, wherein reference image data of various patients are respectively produced, and wherein the respective reference image data are compared in order to obtain study information.

19. The method as claimed in claim 18, wherein the respective reference image data are preprocessed to form a result image that is evaluated in order to obtain study information.

20. The method as claimed in claim 19, wherein the differences between various found sites are optically accentuated in the result image.

21. Medical reference image data of a patient, medical image data produced from the patient being present to present a medical diagnosis, and verification data collected from the patient and correlated with the medical image data being present to verify the diagnosis, wherein:
the diagnosis verified with the aid of the verification data is stored inseparably together with the image data as the medical reference image data.

22. The reference image data as claimed in claim 21, wherein the verification data are collected with the aid of the diagnosis based on a found site in the image data, the found site being stored in the medical reference image data.

23. The reference image data as claimed in claim 21, wherein a portion of the verification data is stored in the reference image data.

24. The reference image data as claimed in claim 21, wherein the found site is stored as image information in the image data of the reference image data.

25. The reference image data as claimed in claim 24, wherein a region marker for a subregion of the image data is stored as found site.

26. The reference image data as claimed in claim 25, wherein an optical accentuation of the subregion is stored as region marker.

27. The reference image data as claimed in claim 21, wherein desired therapy data correlated with the diagnosis are stored in the reference image data for a therapy to be carried out on the patient.

28. The reference image data as claimed in claim 21, wherein, in the course of a therapy carried out on the patient with the aid of the diagnosis, actual therapy data correlated therewith are stored in the reference image data.

29. The method as claimed in claim 2, wherein at least a portion of the verification data is stored in the reference image data.

30. The method as claimed in claim 6, wherein an optical accentuation of a borderline is stored as region marker.

31. The method as claimed in claim 10, wherein at least a portion of the verification data is stored in the reference image data.

32. The method as claimed in claim 14, wherein an optical accentuation of a borderline around the subregion is stored as region marker.

33. A computer readable medium including program segments for, when executed on a computer device, causing the computer device to implement the method of claim 1.

34. A storage medium including the medical reference image data of claim 21.

35. The reference image data as claimed in claim 22, wherein a portion of the verification data is stored in the reference image data.

36. The reference image data as claimed in claim 26, wherein an optical accentuation of a borderline around is stored as region marker.
